(19) United States
(12) Patent Application Publication
(10) Pub. No.: US 2004/0196785 A1
(43) Pub. Date: Oct. 7, 2004

(54) Congestion notification process and system

(76) Inventors: Gopalakrishnan Janakiraman, Sunnyvale, CA (US); Jose Renato Santos, San Jose, CA (US); Yoshio Turner, Redwood City, CA (US)

Correspondence Address: HEWLETT-PACKARD COMPANY, Intellectual Property Administration, P.O. Box 272400, Fort Collins, CO, 80527-2400, US

(21) Appl. No.: 10/404,338

(22) Filed: Apr. 1, 2003

(51) Int. Cl. H04J 1/16

(52) U.S. Cl. 370/229

(57) ABSTRACT

A network system and method is disclosed that may be useful for addressing congestion issues in network systems. A network system in accordance with the teachings of the invention may provide an acknowledgment packet that may contain information useful to determine, in part, network congestion.

### FIELD OF THE INVENTION

The present disclosure relates to a congestion notification process for a communications network, and a network component or system for executing the process.

### BACKGROUND

Network congestion arises when the traffic sent or injected into a communications network (i.e., the number of injected packets or bytes per unit of time) exceeds the capacity of the network. Congestion causes the throughput of useful traffic (i.e., traffic that reaches its destination) to be reduced, because packets hold onto network resources for longer times and/or network resources are consumed by packets that are later discarded. Network congestion may be controlled by executing processes to detect the congestion, to notify the congestion state to appropriate nodes in the network, and to adjust the injection of packets into the network in response to these notifications. Forward Explicit Congestion Notification (FECN) is one particular method of explicit congestion notification, as described in K. K. Ramakrishnan and S. Floyd, “A Proposal to add Explicit Congestion Notification (ECN) to IP,” IETF RFC-2481, January, 1999, where congestion detected at a network switch is signaled to the destination nodes of the data packets involved in the congestion. The destination nodes subsequently propagate this information to the respective source nodes. Destination node signaling as well as the subsequent source node signaling can occur in-band using congestion marker bits in the data packets themselves, or can occur out-of-band using congestion control packets dedicated to carrying congestion information.

In many FECN implementations (e.g., DEC, as described in K. K. Ramakrishnan, R. Jain, “A Binary Feedback Scheme for Congestion Avoidance in Computer Networks,” ACM Transactions on Computer Systems, Vol. 8, No. 2, pp.158-181, 1990 (“Ramakrishnan”), and RED, as described in S. Floyd and V. Jacobson, “Random Early Detection Gateways for Congestion Avoidance,” IEEE/ACM Transactions on Networking, Vol. 1, No. 4, pp.397-413, August 1993 (“Floyd”)), network switches mark packets by changing ECN bits in packet headers to notify the receiver of congestion. The receiver, in turn, includes a congestion marker in the acknowledgment (ACK) that it sends back to the sender. Congestion response processes executed by end (i.e., source) nodes adjust their rates of traffic injection in response to these congestion notifications.

One way to control traffic injection is to limit the number of packets that are concurrently in flight in the network between a pair of communicating sender and receiver nodes. Congestion control in TCP, as described in V. Jacobson, “Congestion avoidance and control,” ACM SIGCOMM 88, pp. 314-329, August 1988, is an example of this window control method. The window control method uses acknowledgments from the receiver to the sender to indicate which packets have been received (i.e., which packets are no longer in flight). The use of ACKs allows the sender to identify transmission failures (when a packet is not ACKed) and trigger packet retransmission. With a window based congestion control process, the ACKs also allow the sender to determine and control the number of packets that are in flight in the network. By blocking packet transmission whenever the number of unacknowledged packets reaches a threshold value, the sender can limit the number of packets that are concurrently in flight in the network.

Although receivers can ACK the receipt of every packet, many network protocols allow receivers to generate ACKs less frequently to reduce the overhead due to acknowledgments. In this specification, such receivers are said to coalesce their ACKs, where the term ‘coalesce’ includes delaying ACKs and other similar methods. As described by M. Allman, V. Paxson, W. Stevens, in “TCP Congestion Control,” IETF RFC 2581, April 1999, TCP permits delayed acknowledgments, but generates ACKs for every second segment (segment refers to the size of data in bytes) and within 500 ms of packet arrival. InfiniBand networks, as described in “InfiniBand Architecture Specification Release 1.0.a,” http://www.InfiniBandta.org, also permit receivers to coalesce ACKs for several successive packets, but allow senders to demand immediate acknowledgement from the receiver by setting an acknowledgement request or AckReq bit in packets.

A coalesced ACK indicates which prior packets have been received. Thus, senders can still determine whether packets were lost in transmission. However, coalescing of ACKs creates two difficulties for window-based congestion control. First, by delaying the generation of ACKs, it delays the delivery of congestion notification to the sender. As a result, the sender may continue to inject a large number of packets into the network, even though network congestion has been detected and notified to the receiver node. Second, the generation of a coalesced ACK can be sufficiently delayed that the ACK does not arrive at the sender before the sender exhausts its window. When the sender exhausts its window, it will be forced to block, resulting in a time-out (and, if not properly implemented, a deadlock). This reduces the utilization of the network fabric.

Prior art FECN (e.g., DEC and RED) and congestion control processes (e.g., TCP) have not adequately addressed situations where receivers can coalesce ACKS. When these prior art processes are used with network protocols that permit receivers to coalesce ACKs, they can cause window based congestion control mechanisms to malfunction. Sources can continue to inject a large number of packets into the network while the network is congested. Although these protocols specify limits on the delay between the arrival of a packet and its acknowledgment (e.g., 500 ms in the case of TCP), these limits are very large, and a sender that has exhausted its window may needlessly block and wait for ACKS, thereby lowering network throughput. It is desired to provide a congestion notification process that alleviates one or more difficulties of the prior art, or at least provides a useful alternative to existing congestion notification processes.

### SUMMARY OF THE INVENTION

In accordance with the present invention, there is provided a congestion notification process for use in a communications network, including:

maintaining pending acknowledgement data for determining when to acknowledge receipt of packets received from a sender;

receiving a packet from said sender, said packet including congestion notification data and acknowledgement request data; and

generating, on the basis of at least one of said congestion notification data, said acknowledgement request data, and said pending acknowledgement data, an acknowledgement packet including said congestion notification data and an acknowledging receipt of one or more packets from said sender.

In accordance with the present invention, there is also provided a congestion notification process for use in a communications network, including:

generating a packet including congestion notification data;

maintaining pending acknowledgement data representing unacknowledged packets sent to a receiver of said packet;

generating acknowledgement request data for said packet on the basis of said pending acknowledgement data; and

sending said packet to said receiver, said packet including said acknowledgement request data.

### BRIEF DESCRIPTION OF THE DRAWINGS

Preferred embodiments of the present invention are hereinafter described, by way of example only, with reference to the accompanying drawings, wherein:

FIG. 1 is a schematic diagram of a sending node and a receiving node communicating via a communications network in accordance with embodiments of the present invention;

FIG. 2 is a flow diagram of a packet sending process executed by the sending node in accordance with embodiments of the present invention;

FIG. 3 is a flow diagram of a packet receiving process executed by the receiving node in accordance with embodiments of the present invention; and

FIG. 4 is a flow diagram of an ACK receiving process executed by the sending node in accordance with embodiments of the present invention.

### DETAILED DESCRIPTION OF THE PREFERRED EMBODIMENTS

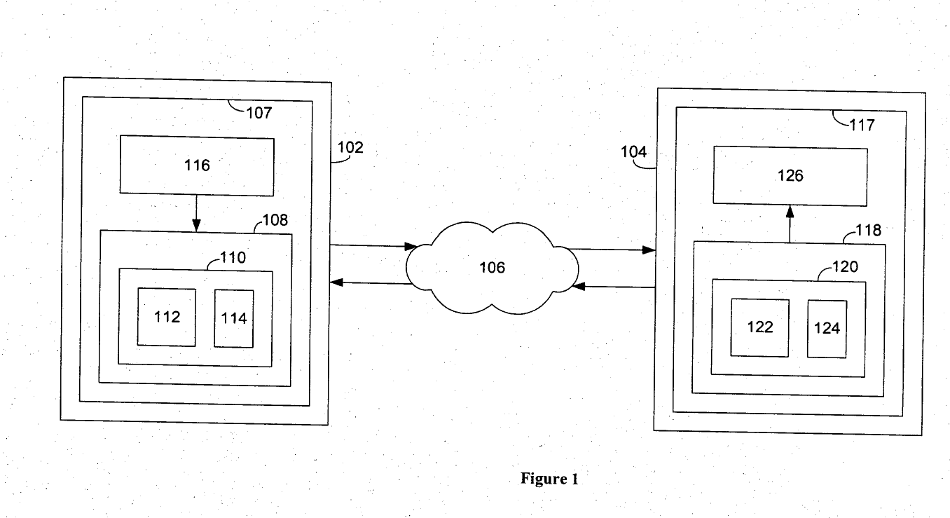

As shown in FIG. 1, a first node 102 and a second node 104 can exchange data via a communications network 106, such as the Internet. The first node 102 includes a storage medium 107 on which is stored an operating system (OS) module 108. The OS module 108 includes a network transport protocol module 110 with congestion notification modules 112 and congestion response modules 114. It will be apparent that the network transport protocol module 110 may alternatively be implemented outside the OS module 110, such as at the user level, or in hardware. The first node 102 also includes a user network application 116, which can be any kind of application that communicates with one or more remote nodes via the networking modules 110 and the network 106. The second node 104 is identical to the first node 102, and includes a storage medium 117 on which is stored operating system modules 118 to 124 identical to respective modules 108 to 114 of the first node 102. The nodes 102, 104 may be standard computer systems such as Intel™-based personal computers with hard disk storage 107, 117, and the operating system 108, 116 is a standard operating system such as Linux™. The network applications 116, 124 may be identical or may be cooperating processes of a parallel application, but are more typically complementary applications forming a client-server pair. Examples of client-server pairs include file sharing and terminal clients and servers, and web browser clients and servers.

For the purposes of illustration, the first node 102 is described below as sending data to the second node 104, and thus the first node 102 is hereinafter referred to as the sending node or sender 102, and the second node 104 is referred to as the receiving node or receiver 104. However, it will be apparent that the second node 104 can also act as a sender, and the first node 102 can also act as a receiver.

The sending and receiving nodes 102, 104 execute forward explicit congestion notification (FECN) processes that facilitate the timely delivery of congestion notifications and acknowledgements from the receiving node 104 to the sending node 102, even when the receiver 104 coalesces acknowledgments, avoiding needless sender blocking. This may allow a window based congestion response process of the sender's congestion response module 114 to operate satisfactorily. However, the congestion notification processes may also be used with network protocols that do not permit ACK coalescing. In the described embodiment, the congestion notification processes are implemented as software of the congestion notification modules 112, 122. However, it will be apparent that at least part of the congestion notification process can be alternatively implemented as dedicated hardware components, such as application-specific integrated circuits (ASICs), in the nodes 102, 104.

The congestion notification processes include a packet receiving process, a packet sending process, and an ACK receiving process, as described below. For clarity, the description below does not include implementation details that are independent of the congestion notification processes, including details of packet transmission and reception, the congestion detection process, the window-based congestion response process that adjusts the congestion window in response to the receipt of acknowledgements and congestion notification, and the ACK coalescing.

A network application 116 executing on the sending node 102 generates application data that is to be sent to the receiving node 104. The sender's networking modules 110 generate and send network data packets that include a congestion notification (CN) marker and an explicit acknowledgment request (AckReq) flag in packet headers, in addition to the application data in the packet body. Similarly, ACK packets returned to the sender 102 to acknowledge receipt of data packets sent by the sender 102 also include the congestion notification (CN) marker, in addition to data identifying the packets that are being acknowledged. Because the CN marker and AckReq flag are effectively two-state or Boolean entities, they are each represented by a single bit in packet headers. However, other representations of these entities can be alternatively used.

The sender 102 sends data packets to the receiver 104 without waiting for acknowledgement of previously sent packets until the number of unacknowledged packets (or, alternatively, bytes of data), NumAckPending, reaches a limit referred to as a congestion window, cwnd. When the sender 102 sends a data packet to the receiver 104, it executes a packet sending process whereby the sender 102 explicitly requests an ACK from the receiver 104 (by setting the AckReq flag in the packet header) if the sender's congestion window cwnd is exhausted. This effectively forces prompt acknowledgement from the receiver 104, and the sender 102 does not need to wait for the receiver 104 to time out in order to receive an acknowledgement.

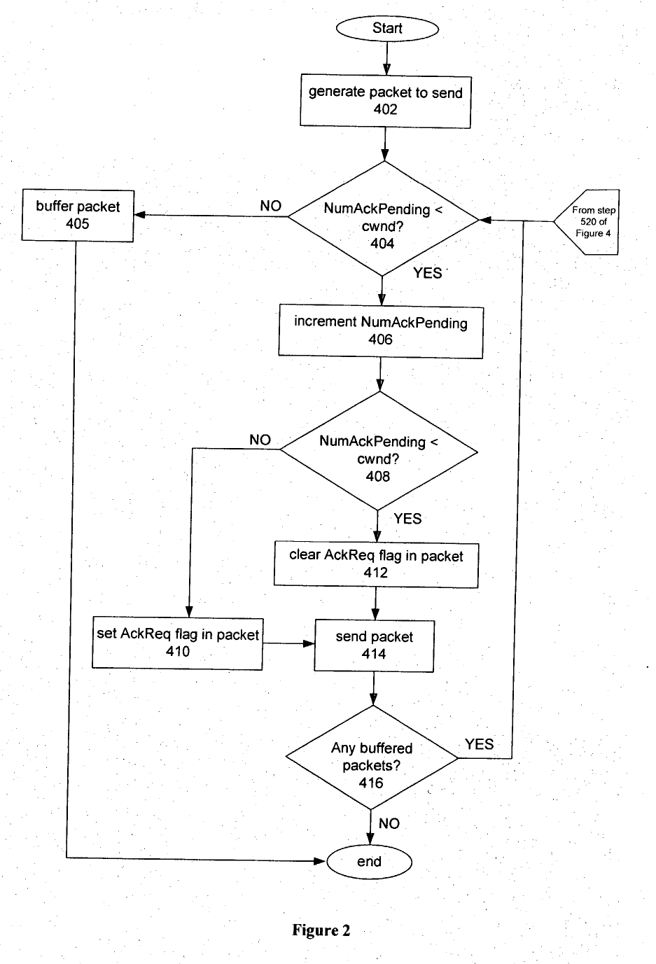

As shown in FIG. 2, the data packet sending process begins at step 402 when a packet containing application data is generated and is ready to be sent. When the packet is generated, the congestion notification marker of the packet header is set to 0. If, at step 404, the number NumAckPending of pending packets (or, alternatively, bytes) for this flow for which acknowledgement has not been received is not less than the congestion window cwnd, then the data packet cannot be sent: the packet is therefore buffered at step 405, and the process ends. Otherwise, if the data packet can be sent, then NumAckPending is incremented at step 406. If, at step 408, its incremented value is less than the congestion window cwnd, then the AckReq flag in the packet header is cleared at step 412. Otherwise, an ACK needs to be forced from the receiver, and hence the AckReq flag in the packet header is set at step 410. In either case, after initializing the flag, the data packet is sent to the receiver 104 at step 414. Subsequently, if it is determined, at step 416, that packets have been buffered, then the process attempts to send these packets by returning to step 404.

During the packet's journey through the network 106 on its way from the sender 102 to the receiver 104, the congestion notification marker CN of the packet may subsequently be set to 1 by a congestion detection process executed at a switch within the network 106 if that switch is experiencing congestion on a link over which the packet travels. As described above, the DEC and RED congestion detection processes, as described in Ramakrishnan and Floyd, are examples of congestion detection processes executed by network switches. However, the congestion notification processes described herein do not require any particular congestion detection process, and the value of the congestion notification marker can be determined by any suitable congestion detection processes.

Network packets can be categorized into flows, where a flow refers to a series of packets sent from a particular source address to a particular destination address. The receiver 104 coalesces ACK packets for each received flow until an implementation dependent pending ACK limit AckInterval is reached. When this limit is reached, the receiver 104 generates an acknowledgement for all packets received from the sender 102 until that time. The AckInterval limit can be determined by various policies, including the number of packets received from the sender 102, the number of bytes of data received from the sender 102, and the elapsed time since the last acknowledgement was sent to the sender 102.

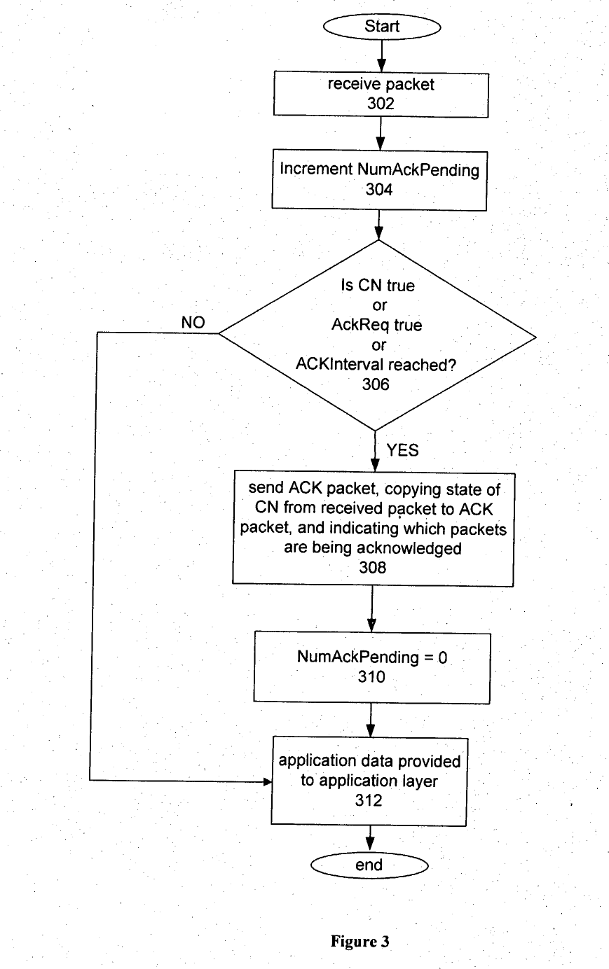

Upon receiving a data packet from the sender 102, the receiver 104 executes the packet receiving process, as shown in FIG. 3. The packet receiving process forwards congestion markers and generates ACKs in a timely fashion based on the state of the CN marker or the AckReq flag in data packet headers. The packet receiving process begins when a data packet is received from the network 106 at step 302. At step 304, the number of pending ACKs, NumAckPending, is incremented by one. At step 306, the value of the CN marker and the AckReq flag are determined by inspecting the packet header. If neither the CN marker nor the AckReq flag is true (i.e., set), and if the pending ACK limit AckInterval has not been reached, then the ACK is delayed. Otherwise, an ACK packet is generated and sent to the sending node 102 at step 308. The ACK packet includes a CN marker with the same value as the CN marker in the received data packet, and an indication of which packets are being acknowledged. Thus the CN marker is effectively forwarded to notify the sending node 102 of congestion, allowing the sending node 102 to reduce the rate of packet transmission to the receiving node 104, or otherwise respond as appropriate. At step 310, the number of pending ACKs, NumAckPending, is set to zero. At step 312, the application data from the received data packet is provided to the application layer, i.e., the receiver's application 126. The process is repeated whenever the receiver receives another data packet from the network 106.

In an alternative embodiment, the pendingACK limit AckInterval represents the number of bytes of data received in a flow before sending an ACK, and NumAckPending is incremented by the number of bytes of data received in the data packet at step 304. In yet a further embodiment, the pending ACK limit AckInterval represents a time limit after which the receiver 104 will generate an ACK, irrespective of the amount of data or number of packets received on that flow. In this embodiment, step 304 is omitted, and NumAckPending represents a timer that is continually updated, and is reset at step 310.

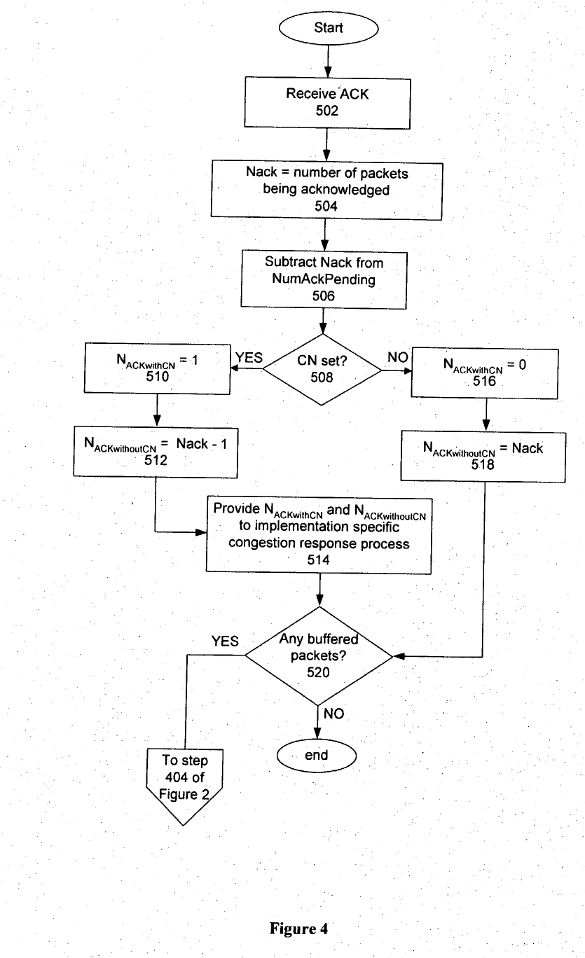

When the sender 102 receives an ACK packet from the receiver 104, the sender 102 executes an ACK receiving process, as shown in FIG. 4, that interprets coalesced ACKs with embedded congestion markers. After receiving an ACK packet at step 502, at step 504 a variable Nack is set to the number of packets being acknowledged, as determined from the ACK packet. At step 506, NumAckPending is decremented by the number of packets (or, alternatively, bytes) that the ACK packet is acknowledging. At step 508, the value of the CN marker is tested. If CN is set, then a variable NackWithCN, representing the number of acknowledged packets whose CN marker was set, is set to 1 at step 510. At step 512, a variable NackWithoutCN, representing the number of acknowledged packets whose CN marker was not set, is set to the number of acknowledged packets less the number of acknowledged packets whose CN marker was set, i.e., NackWithoutCN=Nack−1. These values can then be used by a congestion response process executed by the sending node 102 at step 514 to respond appropriately to the congestion. Alternatively, Nack, NackWithCN, and NackWithoutCN can be expressed in bytes. Otherwise, if, at step 508, the CN marker was not set, NackWithCN is set to 0 at step 516, and NackWithoutCN is set to Nack at step 518.

Irrespective of the value of CN at step 508, if, at step 520, any packets have been buffered at step 405 of the packet sending process, then the packet sending process is executed from step 404 to determine whether one or more of these buffered packets can be sent to the receiver 104. Otherwise, the acknowledgement receiving process ends.

Thus to ensure the timely delivery of congestion notifications from the receiver 104 to the sender 102, the sender requests an explicit acknowledgment from the receiver 104 for at least one packet in a series of data packets that exhausts the sender's congestion window. The receiver 104 is forced to generate an ACK upon the receipt of each packet that demands an explicit ACK (i:e., that has its AckReq flag or its congestion notification (CN) marker set. The resulting ACK acknowledges all packets received up to that point, and also indicates whether the last packet was received with its congestion marker set. When the sender 102 receives an ACK that acknowledges N packets, it reacts to the ACK as follows: if CN is 0, then the reaction of the sender is the same as if N independent ACKs with CN=0 were received. Alternatively, if CN=1, then the reaction of the sender is the same as if N−1 independent ACKs with CN=0 were received, followed by a single ACK with CN=1. The specific actions taken in either case a rein dependent of the congestion notification process and are therefore not described further.

Many modifications will be apparent to those skilled in the art without departing from the scope of the present invention as herein described with reference to the accompanying drawings.

What is claimed is:

1. A congestion notification process for use in a communications network, including:
maintaining pending acknowledgement data for determining when to acknowledge receipt of packets received from a, sender;
receiving a packet from said sender, said packet including congestion notification data and acknowledgement request data; and
generating, on the basis of at least one of said congestion notification data, said acknowledgement request data, and said pending acknowledgement data, an acknowledgement packet including said congestion notification data and an acknowledging receipt of one or more packets from said sender.

2. A congestion notification process as claimed in claim 1, wherein said pending acknowledgement data relates to packets received from said sender since a previous acknowledgement packet was sent.

3. A congestion notification process as claimed in claim 1, wherein said pending acknowledgement data represents an elapsed time since a previous acknowledgement packet was sent.

4. A congestion notification process as claimed in claim 1, wherein said pending acknowledgement data relates to a number of bytes of data received from said sender since a previous acknowledgement packet was sent.

5. A congestion notification process as claimed in claim 1, wherein said congestion notification data represents whether congestion has been detected on a path in said network for said packet.

6. A congestion notification process as claimed in claim 1, wherein said acknowledgement request data indicates whether an acknowledgement is requested by said sender.

7. A congestion notification process as claimed in claim 1, including sending said acknowledgement packet to said sender upon receipt of said data packet if said congestion notification data has a predetermined value.

8. A congestion notification process as claimed in claim 1, including sending said acknowledgement packet to said sender upon receipt of said data packet if said acknowledgement request data has a predetermined value.

9. A congestion notification process as claimed in claim 1, wherein said congestion notification data provides congestion information for said packet.

10. A congestion notification process for use in a communications network, including:
generating a packet including congestion notification data;
maintaining pending acknowledgement data representing unacknowledged packets sent to a receiver of said packet;
generating acknowledgement request data for said packet on the basis of said pending acknowledgement data; and
sending said packet to said receiver, said packet including said acknowledgement request data.

11. A congestion notification process as claimed in claim 10, wherein said step of generating acknowledgement request data includes generating acknowledgement request data for said packet on the basis of a comparison of said pending acknowledgement data with a predetermined value.

12. A congestion notification process as claimed in claim 10, wherein said acknowledgement request data indicates whether an acknowledgement is to be generated by said receiver upon receipt of said packet.

13. A congestion notification process as claimed in claim 10, wherein said step of maintaining pending acknowledgement data includes incrementing said pending acknowledgement data by a quantity of data of said packet.

14. A congestion notification process as claimed in claim 10, wherein said step of maintaining pending acknowledgement data includes incrementing said pending acknowledgement data by one.

15. A congestion notification process as claimed in claim 10, including receiving an acknowledgement of one or more packets sent to said receiver; and determining the number of acknowledged packets including a first congestion notification data value, and the number of acknowledged packets including a second congestion notification data value.

16. A congestion notification process as claimed in claim 15, including executing a congestion response process on t he basis o f said congestion notification data values.

17. A network component having components for executing the steps of claim 10.

18. A computer readable storage medium having stored thereon program code for, executing the steps of claim 10.

19. A system for use in a communications network, including:
means for maintaining pending acknowledgement data for determining when to acknowledge receipt of packets received from a sender;
a network interface for receiving a packet from said sender, said packet including congestion notification data and acknowledgement request data; and
means for generating, on the basis of at least one of said congestion notification data, said acknowledgement request data, and said pending acknowledgement data, an acknowledgement packet including said congestion notification data and an acknowledging receipt of one or more packets from said sender.

20. A system for use in a communications network, including:
means for generating a packet including congestion notification data;
means for maintaining pending acknowledgement data representing unacknowledged packets sent to a receiver of said packet;
means for generating acknowledgement request data for said packet on the basis of said pending acknowledgement data; and
a network interface for sending said packet to said receiver, said packet including said acknowledgement request data.
